(19) United States
(12) Patent Application Publication
(10) Pub. No.: US 2005/0008068 A1
(43) Pub. Date: Jan. 13, 2005

(54) Adsl pre-qualification method comprising echo-canceller optimisation with maximum selectivity

(76) Inventor: Michael Stegherr, Neubiberg (DE)

Correspondence Address: Siemens Corporation;Intellectual Property Departement, 170 Wood Avenue South, Iselin, NJ, 08830, US

(21) Appl. No.: 10/494,793

(22) PCT Filed: Nov. 7, 2002
(86) PCT No.: PCT/DE02/04122

(30) Foreign Application Priority Data
Nov. 8, 2001 (DE) 101 54 937.7

(51) Int. Cl. H04L 5/16

(52) U.S. Cl. 375/222

(57) ABSTRACT

The invention relates to a method for determining one or more characteristics of a line, in addition to a device for determining one or more characteristics of a line that can be directly or indirectly connected to the device. Said device is configured in such a way that it can trigger the emission of a test signal on the line and determine the line characteristic or characteristics from the echo signal received via the line. The device has a signal transformation unit for transforming the echo signal or a signal obtained from said echo signal into the frequency range, the line characteristic or characteristics being determined from a vector that represents the intensity of individual spectral fractions of the frequency range. The invention is characterised in that the device has s signal processing unit, to which the untransformed echo signal or the untransformed signal obtained therefrom is fed, and that the line characteristic or characteristics is/are determined from the comparison of the vector that represents the intensity of individual spectral fractions of the frequency range with several model vectors. The signal processing unit processes the echo signal or the signal obtain therefrom in such a way that model vectors can be chosen so that they are at the greatest possible euclidic distances from one another.

### CROSS REFERENCE TO RELATED APPLICATIONS

This application is the US National Stage of International Application No. PCT/DE02/04122, filed Nov. 7, 2002 and claims the benefit thereof. The International Application claims the benefits of German application No. 10154937.7 filed Nov. 8, 2001, both of the applications are incorporated by reference herein in their entirety.

### FIELD OF INVENTION

The invention relates to a system for determining one or more characteristics of a line which can be connected directly or indirectly to said system.

The invention further relates to a method for determining one or more characteristics of a line.

### BACKGROUND OF INVENTION

Data communication systems generally have a transmitter or transceiver unit, e.g. a first modem provided in an EWSD end office, from where modulated transmission signals are transmitted over a transmission channel, e.g. a subscriber line, to a receiver or another transceiver unit, e.g. to a second modem provided in a subscriber terminal device.

Data communication between the modems (modulators-demodulators) can take place e.g. by means of ISDN (Integrated Services Digital Network) and by means of xDSL (x Digital Subscriber Line), e.g. ADSL data transmission.

For xDSL data transmission, a plurality of frequency bands (bins) are employed which are above the frequency bands used for POTS or ISDN data transmission.

To transmit data in a particular frequency band, a cosinusoidal (or sinusoidal) waveform, for example, is used whose frequency is e.g. in the center of the relevant frequency band.

For example, each bit or bit sequence to be transmitted can be assigned a cosinusoidal waveform of defined amplitude and phase (e.g. using a phase star). If this is transmitted by the relevant transmitter unit over the subscriber line to the receiver unit, the particular bit sequence transmitted can be determined in the receiver unit from the amplitude and phase of the cosinusoidal waveform received.

In addition, there is already known a method whereby, prior to the start of actual data transmission and prior to the connection of a subscriber-end modem (single-ended mode), the relevant transmitter or transceiver unit determines one or more parameters (line length, terminating impedance, position of bridge taps, etc.) characterizing the relevant subscriber line (pre-qualification method).

This means that a future user of the relevant transmitter or transceiver unit or of a modem to be connected can be provided in advance with information concerning the maximum achievable data rate.

A method corresponding to a pre-qualification method (diagnostic method) can also be performed after the connection of a subscriber-end modem (double-ended mode). At commissioning of the relevant transmitter or transceiver unit (and with the subscriber's modem connected), transmission of the (actual) user data is specifically adapted to the particular line parameters determined.

For example, depending on the line parameters determined, more or fewer bits per time unit can be transmitted via the abovementioned frequency bands, i.e. the maximum ADSL transmission bit rate can be defined.

To determine one or more line parameters, e.g. time domain based reflection measuring methods or TDR methods can be used (TDR=Time Domain Reflectometry).

With these methods, e.g. a Dirac test pulse is transmitted over the subscriber line prior to the start of actual data transmission by the relevant transmitter or transceiver unit. The abovementioned line parameters can be estimated from the time position and shape of the signal reflected back to the relevant transmitter or transceiver unit—i.e. by means of time domain based signal analysis.

Alternatively, using frequency based reflection measuring methods (FDR methods, FDR=Frequency Domain Reflectometry), the signals reflected back are transformed to the frequency domain e.g. by means of FFT transformation (FFT=Fast Fourier Transform). The abovementioned line parameters are then determined from the signal spectrum thus obtained.

Also already known from the prior art is the provision of so-called echo suppression devices at the transmitter or transceiver unit.

The signals emitted by the relevant modem—and therefore also the actual (user data) signals—are namely reflected (e.g. at transition points in the subscriber line), resulting in a contribution of the emitted signals to the opposite direction, i.e. to the input signal received from the transceiver unit (“echo signal”).

To eliminate the echo signal (i.e. to determine the actual input signal component coming from the far-end transceiver device), the echo suppression device can have, for example, a device with a filter, e.g. a digital filter with adjustable filter coefficients.

The filter coefficients can be selected such that an (estimated) duplicate of the echo signal is produced by the device and subtracted from the received input signal.

### SUMMARY OF INVENTION

The object of the invention is to provide a novel method for determining one or more characteristics of a line, as well as a novel system for determining one or more characteristics of a line which can be connected directly or indirectly to said system.

The invention achieves this and other objectives as set forth in claims 1 and 20.

Advantageous further developments of the invention are detailed in the sub-claims.

According to a basic idea of the invention, there is provided a system for determining one or more characteristics of a line which can be connected directly or indirectly to the system, said system being implemented in such a way that it can cause a test signal to be sent out over the line, and determines the line characteristic or characteristics from the echo signal received, and said system having a signal transformation device for transforming the echo signal or a signal obtained from said echo signal to the frequency domain, the line characteristic or characteristics being determined from a vector representing the intensity of individual frequency domain spectral components, characterized in that the system has a signal processing device to which the untransformed echo signal or the untransformed signal obtained therefrom is fed, and the line characteristic or characteristics are determined from a comparison of the vector representing the intensity of individual frequency domain spectral components with a plurality of pattern vectors, the signal processing device processing the echo signal or the signal obtained therefrom in such a way that the pattern vectors can be selected in such a way that the euclidean distances between them are as large as possible.

This enables a high degree of selectivity in determining the line characteristic(s) to be achieved.

The line characteristic to be determined can advantageously be e.g. the line length, or e.g. its gauge or terminating impedance, the position of bridge taps, etc.

In an advantageous embodiment, the system can be used not only for determining one or more line characteristics but also for transmitting user data bits over the line.

The test signal sent out by the system is preferably derived from a pseudorandom bit sequence.

The pseudorandom bit sequence is more preferably modulated correspondingly to user data bits transmitted over the line by the system.

Advantageous is an embodiment wherein the pseudorandom bit sequence is DMT modulated, more specifically according to a DSL modulation standard.

Preferably the characteristics of the signal processing performed by the signal processing device are set by adapting one or more filters provided in the signal processing device. Adaptation of the filter(s) can be achieved e.g. by selecting the magnitude of one or more filter coefficients, and/or e.g. by appropriate filter structure selection.

The inventive system for determining line characteristics can be disposed e.g. in an end office. The line characteristics can be determined e.g. before the start of actual (user) data transmission, and prior to connection of a subscriber-end modem (i.e. in single-ended mode) (pre-qualification method).

This means that a user can be provided with information in advance about the maximum achievable data rate even before connection of the corresponding subscriber-end modem.

Alternatively or in addition, the system can be used to determine the abovementioned line characteristics even after connection of the corresponding subscriber-end modem (diagnostic method).

### BRIEF DESCRIPTION OF THE DRAWINGS

The invention will now be explained in greater detail with reference to a plurality of embodiments and the accompanying drawings in which:

FIG. 1 shows a data communication system in which the data transmission method according to the invention is used;

FIG. 2 schematically illustrates a plurality of frequency bands used for DSL data transmission in the data communication system shown in FIG. 1;

FIG. 3 schematically illustrates the modem shown in FIG. 1, as well as the subscriber line;

FIG. 4 schematically illustrates the detail of the signal processing device shown in FIG. 3; and

FIG. 5 schematically illustrates the detail of the digital filter contained in the signal processing device according to FIG. 4.

### DETAILED DESCRIPTION OF INVENTION

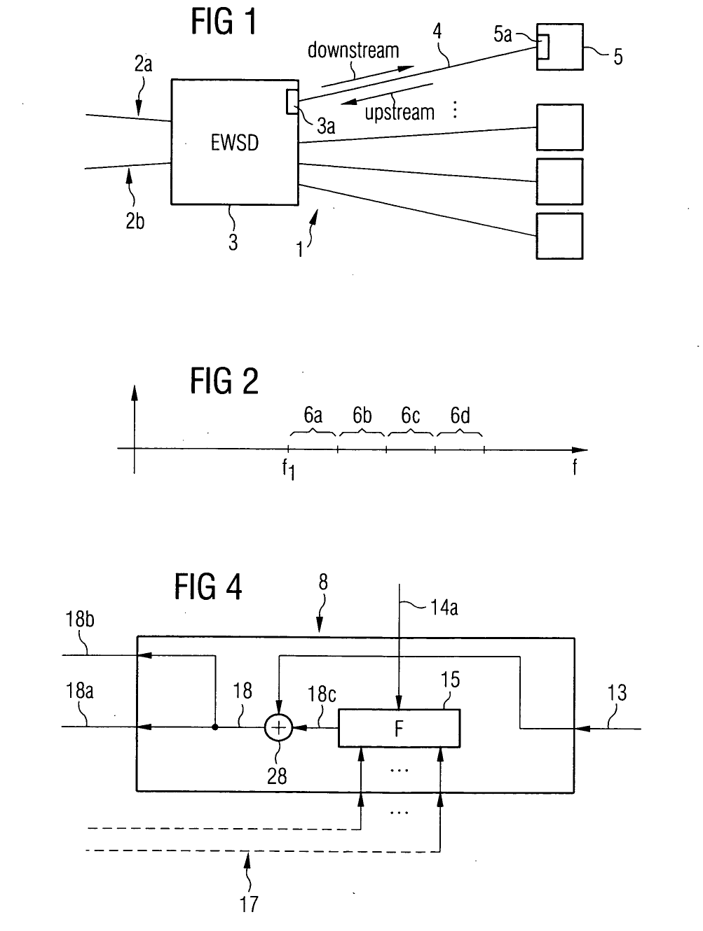

FIG. 1 shows an example of a data communication system 1 in which the pre-qualification method according to the invention can be used.

The data communication system 1 has an end office 3 (in this case an electronic digital switching system or EWSD) connected to a telephone network (in this case the public telephone network 2a). The end office 3 is additionally connected to an IP network 2b (IP=Internet Protocol).

The end office 3 is connected to a plurality of subscriber terminal devices 5 via a plurality of subscriber lines 4.

Data communication between end office 3 and the relevant subscriber terminal device 5 (or between the modems (modulators-demodulators) 3a, 5a provided there) can take place e.g. by means of POTS (Plain Old Telephone Service) or ISDN (Integrated Services Digital Network), and by means of XDSL (x Digital Subscriber Line), e.g. ADSL data transmission.

For DSL data transmission, as shown in FIG. 2, a plurality of frequency bands (bins) 6a, 6b, 6c, 6d above a frequency f1 are used. The frequency ranges below the frequency f1 (f1=25 kHz for POTS or f1=130 kHz for ISDN) are used for conventional POTS or ISDN (voice) data transmission.

For DSL data transmission in the downstream direction, i.e. between the end office modem 3a and the subscriber modem 5a, or vice versa in the upstream direction, i.e. between the subscriber modem 5a and the end office modem 3a, a DMT method, for example, can be used (DMT=Discrete Multi Tone).

For each frequency band 6a, 6b, 6c, 6d, cosinusoidal waveforms are used whose frequency can be e.g. in the center of the relevant frequency band 6a, 6b, 6c, 6d.

The encoding of the data to be transmitted in a cosinusoidal waveform can be performed e.g. in the known manner using a so-called phase star.

Said phase star has a plurality of concentric circles to each of which is assigned a cosinusoidal waveform amplitude of defined magnitude. One or more points to which one of a plurality of different bits or bit sequences is assigned lie on each circle—at different angles in each case. Each of the abovementioned angles is assigned a corresponding cosinusoidal waveform phase shift with respect to a clock running synchronously in the subscriber modem 5a and in the end office modem 3a (or with respect to a pilot tone sent out by the relevant modem 3a, 5a).

Data transmission within the relevant frequency band (bins) 6a, 6b, 6c, 6d can then take place e.g. using a sequence of cosinusoidal waveforms of predefined frequency, via whose amplitude and phase shift one of the abovementioned bits or bit sequences can be characterized in each case. In the relevant receiving modem 3a, 5a, the transmitted bit or the transmitted bit sequence can be determined from the amplitude and phase shift of the cosinusoidal waveform received—using a phase star corresponding to the abovementioned phase star.

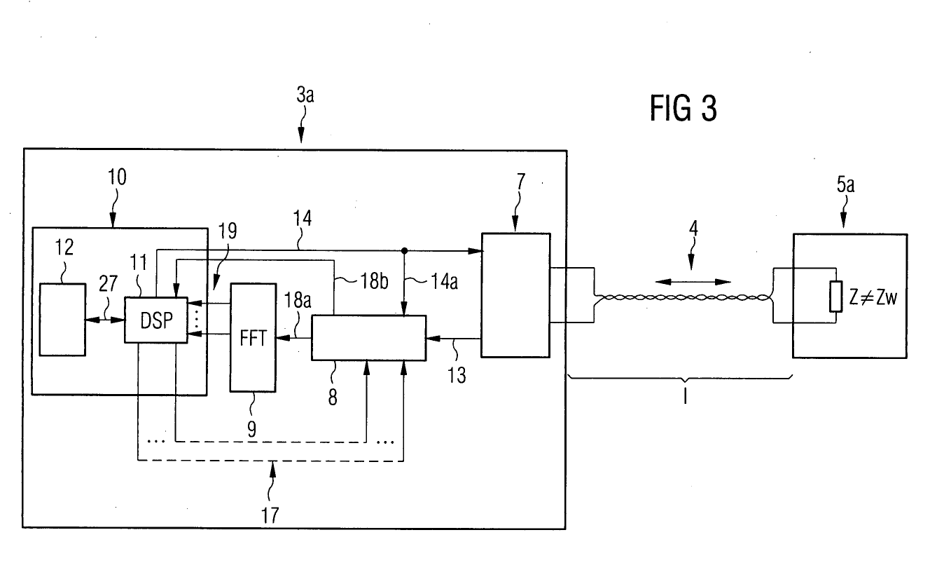

FIG. 3 schematically illustrates the detail of the subscriber modem 5a, the end office modem 3a, and the subscriber line 4 shown in FIG. 3. Said subscriber line is implemented here in the form of a twisted-pair line.

The subscriber line 4 has an—initially unknown—length 1 which is determined by the end office modem 3a by means of the pre-qualification method explained in detail below.

As shown schematically in FIG. 3, because of the internal resistance of the subscriber modem 5a, the subscriber line 4 is terminated with an impedance Z, there being (initially) a mismatch, i.e. the impedance Z of the subscriber modem 5a is not equal to the characteristic impedance Z_{w} of the subscriber line 4.

The impedance Z of the subscriber modem 5a is initially unknown, and can be determined—alternatively or in addition to the line length l—by means of the pre-qualification method described below.

If the terminating impedance Z is known, e.g. impedance matching can then be performed for the end office modem 3a in the known manner.

Alternatively or in addition to the line length l and/or the terminating impedance Z, yet other line parameters can be determined using the pre-qualification method described below, e.g. the position of bridge taps, and/or the gauge of the subscriber line 4, and/or the position of miscellaneous transition points (e.g. adjacent line sections of differing gauge), etc.

The end office modem 3a has a signal conversion device 7, a signal processing device 8, a signal transformation device 9, as well as a transceiver 10. The transceiver comprises a control device 11, e.g. a digital signal processor (DSP), and a memory device 12.

In the signal conversion device 7, 2-wire/4-wire conversion takes place (e.g. in a hybrid circuit,) as well as analog/digital conversion of the input or output signals of the modem 3a (e.g. in one or more digital/analog conversion circuits).

The differential analog signal received via the two wires of the (twisted-pair) subscriber line 4 is converted into a differential digital signal. The digital signal is passed via a line 13 to the signal processing device 8 where the received digital signal undergoes specially optimized “echo suppression” as described below.

In a corresponding manner, a digital signal S sent out over a line 14 by the control device 11 or by the digital signal processor (DSP) is converted in an analog/digital conversion device provided in the signal conversion device 7 to a corresponding analog signal, and then output to the twisted-pair line 4 as a differential signal.

The abovementioned pre-qualification process is carried out prior to actual (user) data transmission, more specifically before connection of the subscriber's modem 5a (single-ended termination). In an alternative embodiment, a method corresponding to the described pre-qualification method is performed prior to actual (user) data transmission at a time when the subscriber's modem 5a is already connected (diagnostic method).

Alternatively or in addition it is also conceivable for corresponding methods to be performed e.g. at predefined or freely selectable time intervals during user data transmission.

Depending on the line parameter(s) determined during the pre-qualification process, e.g. the actual settings relating to DSL user data transmission are then performed (e.g. for actual DSL user data transmission e.g. more or fewer bits per time unit are transmitted via the abovementioned frequency bands 6a, 6b, 6c, 6d, i.e. the maximum DSL transmission bit rate is defined).

Information relating to the selected settings, e.g. relating to the transmission bit rate used, can then be notified by the end office modem 3a to the subscriber modem 5a.

This can take place e.g. by corresponding messages being sent from the end office modem 3a to the subscriber modem 5a prior to the start of actual user data transmission and/or at predefined or freely selectable time intervals during user data transmission (e.g. using free bits provided in the DSL standard (e.g. via bits contained in the ADSL overhead channel or in the embedded operation channel)).

To perform the pre-qualification process, pseudo noise or pseudo noise pulse train signals are first fed out by the control device 11 or by the digital signal processor (DSP) instead of signals containing the actual user data.

For this purpose a pseudorandom bit sequence is read out of the memory device 12 by the control device 11 or the digital signal processor 11, and said pseudorandom bit sequence is assigned—according to the DSL modulation technique explained above—a cosinusoidal waveform or a sequence of cosinusoidal waveforms of defined amplitude and phase in which the pseudorandom bit sequence is encoded.

The DSL-encoded pseudo noise pulse train, i.e. the corresponding cosinusoidal waveform signals, are fed by the control device 11 or the digital signal processor (DSP) via the line 14 to the conversion device 7 where they are converted as described above and then output to the subscriber line 4 as an analog signal.

The signals supplied by the control device 11 or the digital signal processor (DSP) are also fed via a line 14a to the signal processing device 8.

The pseudo noise pulse train signals are (at least partially) reflected at the subscriber modem 5a because of the mismatch of said subscriber modem 5a. Additional reflections may be caused e.g. by transition points on the subscriber line 4, as well as by the hybrid circuit provided in the conversion device 7.

The reflected signal (“echo signal”) received by the end office modem 3a is fed to the conversion device 7 where it is (A/D) converted in the manner described above and then forwarded via the line 13 to the signal processing device 8.

This device, as shown in FIG. 4, has a digital filter device 15 with one (or more, e.g. cascaded) digital filters 16 to which the signals fed out by the DSP or the control device 11 via the line 14a are fed.

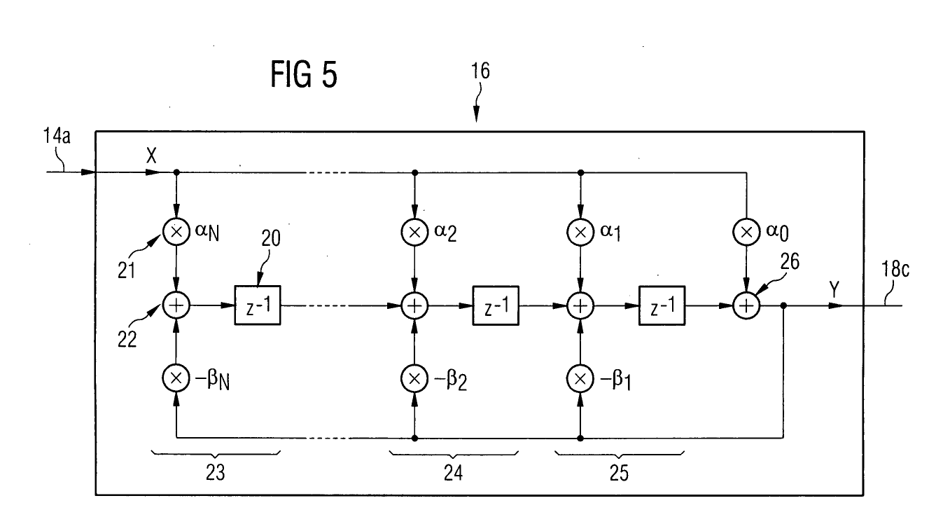

The digital filter(s) can essentially be of any design, e.g. corresponding to the digital filter 16 shown in FIG. 5. The signal produced at the output of the digital filter 16 is forwarded via a line 18c to an adder 28 where the echo signal received from the end office modem 3a via the line 13 is added to the signal.

The signal thus obtained is fed via a line 18 and via a line 18b to the control device 11 or the digital signal processor, and via the line 18 and a line 18a to the signal transformation device 9 (FIG. 3).

Again referring to FIG. 5, the digital filter 16 has one or more filter sections, in this case a first filter section 23, and further filter sections 24, 25. Each filter section comprises, for example, a delay element 20 (in alternative embodiments: two delay elements), two multipliers 21, and an adder 22, 26 (only the first and last, Nth section is of simpler design). The number N of filter sections 23, 24, 25 specifies the order of the filter.

The multipliers 21 multiply the signals present by filter coefficients of adjustable magnitude α₀, α₁, α₂, . . . , α_{N}, β₁, β₂ . . . , β_{N}.

The magnitude of the filter coefficients α₀, α₁, α₂, . . . , α_{N}, β₁, β₂ . . . , β_{N} is determined by the control device 11 or by the digital signal processor, as will be explained in greater detail below.

After they have been determined by the control device 11 or the digital signal processor, the filter coefficients α₀, α₁, α₂, . . . , α_{N}, β₁, β₂ . . . , β_{N} can be set to the appropriate values, as shown in FIGS. 3 and 4, by the control device 11 or the digital signal processor transmitting appropriate coefficient setting signals via control lines 17 to the digital filter device 15 or the digital filter 16.

Again referring to FIG. 5, the signals supplied by the multiplier 21 are fed to the relevant adder 22, and from there to the relevant delay element 20. The last adder 26 of the last, Nth filter section 25 is connected to the output of the digital filter 16, and therefore to the line 18, via which it provides the abovementioned filter output signal.

After addition with signal provided via the line 13, this signal is forwarded, as already explained, via the lines 18, 18a to the signal transformation device 9 where the received signal is transformed to the frequency domain, more specifically using discrete Fourier transformation (DFT), e.g. FFT (Fast Fourier Transformation), or other orthogonal transformation methods.

The magnitude of all or individually selected spectral components (e.g. of number n) of the signal spectrum obtained is forwarded by means of corresponding signals via a plurality of lines 19 (in this case of number n) to the control device 11 or the digital signal processor.

In the control device 11 or the digital signal processor, a vector V representing the magnitude of the abovementioned n spectral components is compared with k pattern vectors V_{M1}, V_{M2}, V_{M3}, . . . , V_{Mk} (pattern matching analysis)

The k pattern vectors V_{M1}, V_{M2}, V_{M3}, . . . , V_{Mk} are stored in the memory device 12, and are read out of the memory device 12 via corresponding bus lines 27 by the control device 11 or the digital signal processor.

Each of the k pattern vectors V_{M1}, V_{M2}, V_{M3}, . . . , V_{Mk} represents one of k different values for a particular line parameter (or alternatively one of k different combinations of two or more different line parameters), e.g. k different line lengths l₁, l₂, l₃, . . . , lₖ (in arbitrarily selected units)

The distances between different, consecutive line lengths (e.g. between l₁ and l₂, and between l₂ and l₃) can be of different sizes.

The control device 11 or the digital signal processor determines which of the k pattern vectors V_{M1}, V_{M2}, V_{M3}, . . . , V_{Mk} is the most similar to the abovementioned vector V, and therefore—because of the abovementioned assignment between the k pattern vectors V_{M1}, V_{M2}, V_{M3}, . . . , V_{Mk} and particular line parameter values (or sets of values for various line parameters)—obtains an estimate for the corresponding line parameter of the subscriber line 4 (or estimates for a plurality of different subscriber line parameters), e.g. an estimate l₁, l₂, l₃, . . . , lₖ for the line length.

The filter coefficients α₀, α₁, α₂, . . . , α_{N}, β₁, β₂ . . . , β_{N} are set by the control device 11 or the digital signal processor in such a way that the pattern vectors V_{M1}, V_{M2}, V_{M3}, . . . , V_{Mk} assigned to the line parameters l₁, l₂, l₃, . . . , lₖ. or line parameter combinations to be determined are as different as possible in n-dimensional vector solution space or that the euclidean (or other suitable) distances between them are as large as possible (correspondingly similar to the maximally large Hamming distances between the coding patterns used for encoding).

Any two pattern vectors (V_{M1} and V_{M2}, or V_{M2} and V_{M3}, V_{M1} and V_{M3}) assigned to any two line parameter combinations or line parameters (e.g. l₁ and l₂, or l₂ and l₃, or l₁ and l₃, etc.) must be as different as possible, thereby achieving a high degree of selectivity.

The filter coefficients α₀, α₁, α₂, . . . , α_{N}, β₁, β₂ . . . , β_{N} are set e.g. prior to (initial) commissioning of the end office modem 3a or prior to the start of actual data transmission. During operation of the end office modem 3a, the filter coefficient setting selected can be e.g. changed, adapted, or corrected.

For the setting of the filter coefficients α₀, α₁, α₂, . . . , α_{N}, β₁, β₂ . . . , β_{N} by the control device 11 or the digital signal processor, various lines each having different line parameters l₁, l₂, l₃, . . . , lₖ or line parameter combinations can be simulated there (e.g. by simulating corresponding lines by means of corresponding differential equations in the signal processing path of the digital signal processor).

During simulation, the subscriber line 4 is decoupled from the end office modem 3a in response to a signal supplied by the control device 11 or the digital signal processor to a relay (not shown) (line length 0).

In alternative embodiments, the filter coefficients α₀, α₁, α₂, . . . , α_{N}, β₁, β₂ . . . , β_{N} are not set by the control device 11 or the digital signal processor, but fixed in advance.

In another alternative embodiment, the signal processing device 8 can be used as a conventional echo suppression device during transmission of the actual user data signals.

The filter coefficients of one or more digital filters contained in the signal processing device 8 are then set by the control device 11 or the digital signal processor in such a way that, from a user data signal (fed e.g. via the line 14a,) an (estimated) duplicate of the echo signal caused by said user data signal is produced by the signal processing device 8.

This signal is subtracted from the signal received from the conversion device 7 via the line 13, and the resulting (echo suppressed) signal is forwarded via the line 18b to the control device 11 of the digital signal processor.

Alternatively or in addition, the signal processing device 8 and the (FFT) signal transformation device 9 can be implemented in one and the same component, e.g. in a mixed transversal/recursive circuit entity with m outputs.

In other alternative embodiments, other settings in addition to filter coefficient settings can be performed by the control device 11 or the digital signal processor for the abovementioned optimization of the pre-qualification process in respect of pattern vectors V_{M1}, V_{M2}, V_{M3}, . . . , V_{Mk} with maximally large (euclidean) distances.

For example, the structure of the filter (e.g. its order (number N of filter sections 23, 24, 25), recursive auxiliary portion, etc.) can be selected so as to produce maximally large pattern vector distances.

Alternatively or in addition, analysis of the signals supplied by the signal processing device 8 (i.e. the abovementioned vector comparison or pattern matching) for the abovementioned pre-qualification process can be performed not by the control device 11 or the digital signal processor itself, but by a (separate) host processor (e.g. by a microcontroller disposed on the corresponding modem module and performing other general tasks for one or more modems).

1-20. (cancelled)

21. A system for determining one or more characteristics of a line which can be connected directly or indirectly to the system, the system being implemented in such a way that it can cause a test signal to be output to the line and determines the line characteristic or characteristics from the echo signal received via the line, and the system comprising:
a signal transformation device for transforming the echo signal or a signal derived from said echo signal to the frequency domain, the line characteristic or characteristics being determined from a vector representing the intensity of individual frequency domain spectral components; and
a signal processing device to which the untransformed echo signal or the untransformed signal derived therefrom is fed, wherein
the line characteristic or characteristics are determined from a comparison of the vector representing the intensity of individual frequency domain spectral components with a plurality of pattern vectors, and wherein
the signal processing device processing the echo signal or the signal derived therefrom in such a way that the pattern vectors can be selected in such a way that they exhibit maximally large euclidean distances.

22. A system according to claim 21, wherein the characteristics of the signal processing performed by the signal processing device are fixed prior to commissioning of the system.

23. A system according to claim 21, wherein the characteristics of the signal processing performed by the signal processing device can be set during operation of the system by the system itself.

24. A system according to claim 22, wherein the characteristics of the signal processing performed by the signal processing device can be set by adapting one of the filters provided in the signal processing device.

25. A system according to claim 24, wherein the adapting of the filter is achieved by selecting the magnitude of one or more filter coefficients.

26. A system according to claim 24, wherein the adapting of the filter is achieved by selecting the filter structure.

27. A system according to claim 21, wherein the system is used for transmitting user data bits via the line.

28. A system according to claim 21, wherein the test signal is derived from a pseudorandom bit sequence.

29. A system according to claim 28, wherein the pseudorandom bit sequence is modulated correspondingly to user data bits transmitted via the line by the system.

30. A system according to claim 28, wherein the pseudorandom bit sequence is DMT modulated.

31. A system according to claim 28, wherein the pseudorandom bit sequence is DSL modulated.

32. A system according to claim 21, wherein discrete Fourier transformation is used for transforming the echo signal or the signal derived from said echo signal to the frequency domain.

33. A system according to claim 32, wherein Fast Fourier transformation is used for signal transformation.

34. A system according to claim 21, wherein the characteristic to be determined is the length of the line.

35. A system according to claim 21, wherein the characteristic to be determined is the gauge of the line.

36. A system according to claim 21, wherein the characteristic to be determined is the terminating impedance of the line.

37. A system according to claim 21, further comprising a control device, which causes the test signal to be output.

38. A system according to claim 37, wherein determination of the characteristic or characteristics of the line is performed by the same control device, which also causes the test signal to be output.

39. A system according to claim 37, wherein determination of the characteristic or characteristics of the line is performed by a second control device.

40. A system according to claim 37, wherein the control device is a digital signal processor.

41. A system according to claim 39, wherein the second control device is a host processor.

42. A method for determining one or more characteristics of a line (4), having the following steps:
outputting a test signal to the line; and
determining the line characteristic or characteristics from the echo signal received via the line, wherein
the echo signal or a signal derived from said echo signal being transformed to the frequency domain, wherein
the line characteristic or characteristics being determined from a vector representing the intensity of individual frequency domain spectral components, wherein
untransformed echo signal or the untransformed signal derived therefrom undergoes signal processing in a signal processing device, wherein
the line characteristic or characteristics are determined from a comparison of the vector representing the intensity of individual frequency domain spectral components with a plurality of pattern vectors, and wherein
the signal processing device processing the echo signal or the signal derived therefrom in such a way that the pattern vectors can be selected in such a way that they exhibit maximally large euclidean distances.
